(19) United States
(12) Patent Application Publication
(10) Pub. No.: US 2022/0416222 A1
(43) Pub. Date: Dec. 29, 2022

(54) MEMBER FOR SODIUM ION SECONDARY BATTERIES, AND SODIUM ION SECONDARY BATTERY

(71) Applicant: NIPPON ELECTRIC GLASS CO., LTD., Otsu-shi, Shiga (JP)

(72) Inventors: Junichi IKEJIRI, Otsu-shi (JP); Hideo YAMAUCHI, Otsu-shi (JP); Kei TSUNODA, Otsu-shi (JP)

(21) Appl. No.: 17/778,878

(22) PCT Filed: Dec. 18, 2020
(86) PCT No.: PCT/JP2020/047377

§ 371 Date: May 23, 2022

(30) Foreign Application Priority Data
Dec. 24, 2019 (JP) 2019-232200

(51) Int. Cl. H01M 4/134; H01M 4/62; H01M 4/04; H01M 10/0562; H01M 10/054

(52) U.S. Cl. CPC H01M 4/134; H01M 4/62; H01M 4/0426; H01M 10/0562; H01M 10/054; H01M 2300/0071

(57) ABSTRACT

Provided are a member for a sodium-ion secondary battery and a sodium-ion secondary battery both of which are not susceptible to deterioration of charge/discharge cycle characteristics due to charge and discharge. A member 8 for a sodium-ion secondary battery includes: a solid electrolyte layer 2 having sodium-ion conductivity; a metallic sodium layer 6 disposed on one principal surface 2b of the solid electrolyte layer 2 and made of metallic sodium; and a metallic layer 5 provided between the solid electrolyte layer 2 and the metallic sodium layer 6 and made of a metal different from the metallic sodium.

### TECHNICAL FIELD

The present invention relates to members for sodium-ion secondary batteries and sodium-ion secondary batteries.

### BACKGROUND ART

Lithium-ion secondary batteries have secured their place as high-capacity and light-weight power sources essential for mobile devices, electric vehicles, and so on. However, current lithium-ion secondary batteries employ as their electrolytes, mainly, combustible organic electrolytic solutions, which raises concerns about the risk of burning or the like. As a solution to this problem, developments of lithium-ion secondary batteries using a solid electrolyte instead of an organic electrolytic solution have been promoted (see, for example, Patent Literature 1). Furthermore, because, as for lithium, there are concerns about such issues as global rise in raw material costs, studies have recently been conducted on sodium-ion secondary batteries as alternatives to lithium-ion secondary batteries. Patent Literature 2 describes an embodiment in which a metallic sodium layer is used as a negative electrode layer.

### CITATION LIST

### Patent Literature

[PTL 1]

JP-A-H05-205741

[PTL 2]

JP-A-2010-15782

### SUMMARY OF INVENTION

### Technical Problem

Secondary batteries serving as power sources for electric vehicles or the like are required to have high energy density in order to increase the vehicle cruising distance. In this relation, sodium-ion secondary batteries in which metallic sodium is used as a negative electrode as in Patent Literature 2 have higher operating voltages as compared with the case where another metal is used as a negative electrode, and, as a result, the sodium-ion secondary batteries are likely to have high energy density. However, when metallic sodium is used as a negative electrode, there arises a problem that the charge/discharge cycle characteristics easily deteriorate. This tendency is significant particularly when β″-alumina is used as a solid electrolyte.

An object of the present invention is to provide a member for a sodium-ion secondary battery and a sodium-ion secondary battery both of which have excellent charge/discharge cycle characteristics.

### Solution to Problem

A member for a sodium-ion secondary battery according to the present invention includes: a solid electrolyte layer having sodium-ion conductivity; a metallic sodium layer disposed on one of both principal surfaces of the solid electrolyte layer and made of metallic sodium; and a metallic layer provided between the solid electrolyte layer and the metallic sodium layer and made of a metal different from the metallic sodium.

In the present invention, the metallic layer is preferably a vapor-deposited film or a sputtered film.

In the present invention, the metallic layer preferably contains at least one type of metal selected from the group consisting of Sn, Ti, Bi, Au, Al, Cu, Sb, and Pb.

In the present invention, at least one type of metal contained in the metallic layer is preferably a metal capable of absorbing and releasing sodium ions.

In the present invention, at least one type of metal contained in the metallic layer is preferably alloyed, at an interface between the metallic sodium layer and the metallic layer, with the metallic sodium contained in the metallic sodium layer.

A sodium-ion secondary battery according to the present invention includes the above-described member for a sodium-ion secondary battery.

In the present invention, it is preferred that the solid electrolyte layer has a first principal surface and a second principal surface opposed to each other, the sodium-ion secondary battery includes a positive electrode layer provided on the first principal surface of the solid electrolyte layer and a negative electrode layer provided on the second principal surface of the solid electrolyte layer, and the negative electrode layer contains the metallic sodium layer and the metallic layer.

### Advantageous Effects of Invention

The present invention enables provision of a member for a sodium-ion secondary battery and a sodium-ion secondary battery both of which have excellent charge/discharge cycle characteristics.

### BRIEF DESCRIPTION OF DRAWINGS

FIG. 1 is a schematic cross-sectional view showing a sodium-ion secondary battery according to one embodiment of the present invention.

FIG. 2 is a graph showing the relationship between the number of cycles and the average discharge voltage in test batteries produced in working examples and a comparative example.

FIG. 3 is a graph showing the relationship between the number of cycles and the discharge capacity retention in the test batteries produced in the working examples and the comparative example.

FIG. 4 is a graph showing charge and discharge curves in the first cycle and the 50th cycle in a test battery produced in Example 1.

FIG. 5 is a graph showing charge and discharge curves in the first cycle and the 50th cycle in a test battery produced in Example 2.

FIG. 6 is a graph showing charge and discharge curves in the first cycle and the 50th cycle in a test battery produced in Example 3.

FIG. 7 is a graph showing charge and discharge curves in the first cycle and the 50th cycle in a test battery produced in Comparative Example 1.

FIG. 8 is a schematic cross-sectional view showing a sodium-ion secondary battery of the comparative example.

### DESCRIPTION OF EMBODIMENTS

Hereinafter, a description will be given of a preferred embodiment. However, the following embodiment is merely illustrative and the present invention is not intended to be limited to the following embodiment. Throughout the drawings, members having substantially the same functions may be referred to by the same reference characters.

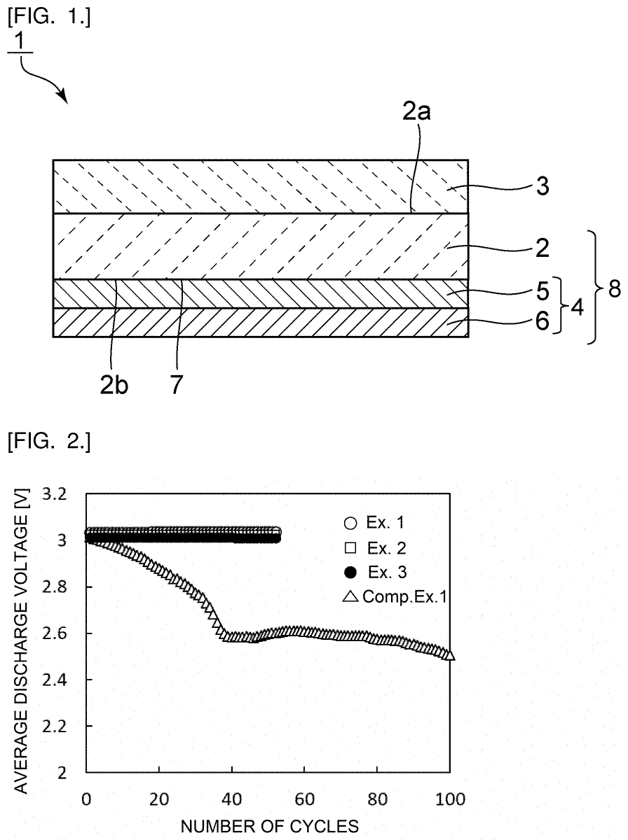

FIG. 1 is a schematic cross-sectional view showing a sodium-ion secondary battery (sodium-ion all-solid-state secondary battery) according to an embodiment of the present invention. As shown in FIG. 1, a sodium-ion secondary battery 1 includes a solid electrolyte layer 2 having sodium-ion conductivity. The solid electrolyte layer 2 has a first principal surface 2a and a second principal surface 2b opposed to each other. A positive electrode layer 3 is provided on the first principal surface 2a of the solid electrolyte layer 2. Furthermore, a negative electrode layer 4 is provided on the second principal surface 2b of the solid electrolyte layer 2. The negative electrode layer 4 includes a metallic layer 5 and a metallic sodium layer 6. The metallic sodium layer 6 is provided on the metallic layer 5. In other words, the metallic layer 5 is provided between the solid electrolyte layer 2 and the metallic sodium 6. The metallic sodium layer 6 is made of metallic sodium. The metallic layer 5 is made of a metal different from metallic sodium. A laminate of the solid electrolyte layer 2 and the negative electrode layer 4 (i.e., a laminate of the solid electrolyte layer 2, the metallic layer 5, and the metallic sodium layer 6) constitutes a member 8 for a sodium-ion secondary battery.

In the sodium-ion secondary battery 1 according to this embodiment, the metallic layer 5 is provided between the solid electrolyte layer 2 and the metallic sodium layer 6. Therefore, the charge/discharge cycle characteristics of the sodium-ion secondary battery 1 can be increased. The reason for this can be explained as follows with reference to a comparative example shown in FIG. 8.

As shown in FIG. 8, in a conventional sodium-ion secondary battery 101 in which a metallic sodium layer serving as a negative electrode layer 104 is provided directly on a second principal surface 102b of a solid electrolyte layer 102, there arises a problem that its charge/discharge cycle characteristics easily deteriorate.

The inventors conducted intensive studies on causes of the above problem and, as a result, found that the adhesiveness between the negative electrode layer 104 and the solid electrolyte layer 102 is poor because of poor wettability of metallic sodium to the solid electrolyte layer 102, repeated charge and discharge cause unevenness in in-plane resistance at the interface 107 between the negative electrode layer 104 and the solid electrolyte layer 102, and this presents the problem that the cycle characteristics deteriorate. The cause of occurrence of unevenness in in-plane resistance at the interface 107 between the negative electrode layer 104 and the solid electrolyte layer 102 can be considered as follows.

In charging and discharging such a sodium-ion secondary battery 101 as shown in FIG. 8, a discharge in which sodium ions contained in the negative electrode layer 104 migrate toward the positive electrode layer 103 and a charge in which, contrariwise, sodium ions migrate from the positive electrode layer 103 toward the negative electrode layer 104 are repeated. However, since the wettability of metallic sodium contained in the negative electrode layer 104 to the solid electrolyte layer 102 is poor, the interface 107 includes portions forming poor contact between the solid electrolyte layer 102 and the negative electrode layer 104. It can be considered that, in the portions forming poor contact between the solid electrolyte layer 102 and the negative electrode layer 104, sodium ions coming from the positive electrode layer 103 cannot migrate to the negative electrode layer 104, are left in the second principal surface 102b of the solid electrolyte layer 102, and precipitate therein as acicular crystals, such as sodium dendrites. It can be considered that these acicular crystals, such as sodium dendrites, form high-resistance portions at the interface 107 between the negative electrode layer 104 and the solid electrolyte layer 102 and, therefore, unevenness in in-plane resistance at the interface 107 occur. As thus far described, it can be considered that, in the sodium-ion secondary battery 101 of the comparative example, repeated charge and discharge cause unevenness in in-plane resistance at the interface 107 between the negative electrode layer 104 and the solid electrolyte layer 102, so that the cycle characteristics deteriorate.

Unlike the above, in the sodium-ion secondary battery 1 according to this embodiment, the metallic layer 5 is provided between the solid electrolyte layer 2 and the metallic sodium layer 6, which increases the adhesiveness between the negative electrode layer 4 and the solid electrolyte layer 2. Therefore, the in-plane resistance at the interface 7 between the negative electrode layer 4 and the solid electrolyte layer 2 can be made uniform, which makes it less likely that the distribution of electrons at the interface 7 is biased. Thus, even when charge and discharge are repeated, uniform migration of sodium ions at the interface 7 is likely to occur and, as a result, the deterioration of the cycle characteristics can be suppressed.

Hereinafter, a description will be given of details of the layers constituting the sodium-ion secondary battery 1.

(Solid Electrolyte Layer)

The solid electrolyte layer 2 is made of a solid electrolyte having sodium-ion conductivity. The solid electrolyte layer 2 can be produced by mixing raw material powders, forming the mixed raw material powders into a shape, and then firing them. For example, the solid electrolyte layer 2 can be produced by making the raw material powders into a slurry, forming the slurry into a green sheet, and then firing the green sheet. Alternatively, the solid electrolyte layer 2 may be produced by the sol-gel method.

Examples of the solid electrolyte powder include beta-alumina and NASICON crystals both of which have excellent sodium ion-conductivity. Particularly, beta-alumina is preferably used as the solid electrolyte powder. In this case, the deterioration of the cycle characteristics can be more effectively suppressed.

Beta-alumina includes two types of crystals: β-alumina (theoretical composition formula: Na₂O.11Al₂O₃) and β″-alumina (theoretical composition formula: Na₂O.5.3Al₂O₃). β″-alumina is a metastable material and is therefore generally used in a state in which Li₂O or MgO is added as a stabilizing agent thereto. β″-alumina has a higher sodium-ion conductivity than β-alumina. Therefore, β″-alumina alone or a mixture of β″-alumina and β-alumina is preferably used and Li₂O-stabilized β″-alumina (Na_{1.7}Li_{0.3}Al_{10.7}O₁₇) or MgO-stabilized β″-alumina ((Al_{10.32}Mg_{0.68}O₁₆)(Na_{1.68}O)) is more preferably used.

Examples of the NASICON crystal include Na₃Zr₂Si₂PO₁₂, Na_{3.2}Zr_{1.3}Si_{2.2}P_{0.7}O_{10.5}, Na₃Zr_{1.6}Ti_{0.4}Si₂PO₁₂, Na₃Hf₂Si₂PO₁₂, Na_{3.4}Zr_{0.9}Hf_{1.4}Al_{0.6}Si_{1.2}P_{1.8}O₁₂, Na₃Zr_{1.7}Nb_{0.24}Si₂PO₁₂, Na_{3.6}Ti_{0.2}Y_{0.7}Si_{2.8}O₉, Na₃Zr_{1.88}Y_{0.12}Si₂PO₁₂, Na_{3.12}Zr_{1.88}Y_{0.12}Si₂PO₁₂, and Na_{3.6}Zr_{0.13}Yb_{1.67}Si_{0.11}P_{2.9}O₁₂, and Na_{3.12}Zr_{1.88}Y_{0.12}Si₂PO₁₂ is particularly preferred because it has excellent sodium-ion conductivity.

The thickness of the solid electrolyte layer 2 is preferably in a range of 5 μm to 150 μm and more preferably in a range of 20 μm to 200 μm. If the thickness of the solid electrolyte layer 2 is too small, the mechanical strength decreases and, thus, the solid electrolyte layer 2 is liable to breakage. Therefore, an internal short circuit is likely to develop. If the thickness of the solid electrolyte layer 2 is too large, the distance of sodium-ion conduction accompanying charge and discharge becomes long and the internal resistance therefore becomes high, so that the discharge capacity and the operating voltage are likely to decrease. In addition, the energy density per unit volume of the sodium-ion secondary battery 1 may decrease.

(Positive Electrode Layer)

The type of the positive electrode layer 3 is not particularly limited so long as it contains a positive-electrode active material capable of absorbing and releasing sodium ions and functions as a positive electrode layer.

Examples of types of active material crystals acting as the positive-electrode active material include sodium transition metal phosphate crystals containing Na, M (where M represents at least one transition metal element selected from Cr, Fe, Mn, Co, V, and Ni), P, and O. Specific examples include Na₂FeP₂O₇, NaFePO₄, Na₃V₂ (PO₄)₃, Na₂NiP₂O₇, Na_{3.64}Ni_{2.18} (P₂O₇)₂, Na₄Ni₃ (PO₄)₂ (P₂O₇), Na₂CoP₂O₇ and Na_{3.64}Co_{2.18} (P₂O₇)₂. These sodium transition metal phosphate crystals are preferred because they have high capacity and excellent chemical stability. Among them, preferred crystals are triclinic crystals belonging to space group P1 or P-1 and, particularly, crystals represented by a general formula NaₓM_{y}P₂O_{z} (where 1.2≤x≤2.8, 0.95≤y≤1. 6, and 6.5≤z≤8) because these types of crystals have excellent cycle characteristics. Other types of active material crystals acting as the positive-electrode active material include layered sodium transition metal oxide crystals, such as NaCrO₂, Na_{0.7}MnO₂, and NaFe_{0.2}Mn_{0.4}Ni_{0.4}O₂. The positive-electrode active material crystals contained in the positive electrode layer 3 may be in a single phase in which a single type of crystals precipitate, or may be in the form of mixed crystals in which a plurality of types of crystals precipitate.

The positive electrode layer 3 can be obtained by applying a slurry containing a positive-electrode active material precursor powder onto the first principal surface 2a of the solid electrolyte layer 2, drying the slurry, and then firing the slurry. By firing the positive-electrode active material precursor powder, active material crystals precipitate and these active material crystals act as the positive-electrode active material. The slurry may contain a solid electrolyte powder and/or a conductive agent. Furthermore, the slurry may contain, as necessary, a binder, a plasticizer, a solvent, and/or so on.

The solid electrolyte powder used may be the same material as the material constituting the above-described solid electrolyte layer 2.

For example, a conductive carbon can be used as the conductive agent. Examples of the conductive carbon include acetylene black and carbon black.

(Negative Electrode Layer)

The negative electrode layer 4 includes a metallic layer 5 and a metallic sodium layer 6.

When the metallic layer 5 is provided between the solid electrolyte layer 2 and the metallic sodium layer 6, the adhesiveness between the negative electrode layer 4 and the solid electrolyte layer 2 can be increased, so that the deterioration of the cycle characteristics in the sodium-ion secondary battery 1 can be suppressed. In addition, the sodium-ion-conducting path can be increased, so that the rate characteristics can be increased.

The type of metal making up the metallic layer 5 is not particularly limited, but examples that can be used include Sn, Ti, Bi, Au, Al, Cu, Sb, and Pb. These types of metals for making up the metallic layer 5 may be used singly or in combination of two or more of them. Alternatively, the metallic layer 5 may be made of a compound of any of these types of metals.

Among the above-described types of metals, a metal capable of absorbing and releasing sodium ions may be appropriately used as at least one type of metal in the metallic layer 5. Examples of this type of metal include Sn, Bi, and Au. Au having a low absorption and release potential is particularly preferably used. The use of such type of metal is preferred because the metal is alloyed with metallic sodium during charge and discharge, which provides the effect of further increasing the adhesiveness between the metallic layer 5 and the metallic sodium layer 6 and the effect of making the conduction of sodium ions through the negative electrode layer 4 more uniform. With the use of Au as the metallic layer 5, the following reactions during charge and discharge occur to promote the alloying with metallic sodium.

Initial charge reaction: Au+Na→Na₂Au

Initial discharge reaction: Na₂Au→NaAu₂

Reactions in second and later cycles: NaAu←Na₂Au

The metallic layer 5 is formed on the second principal surface 2b of the solid electrolyte layer 2. Examples of the method for forming the metallic layer 5 include physical vapor deposition methods, such as evaporation coating and sputtering, and chemical vapor deposition methods, such as thermal CVD, MOCVD, and plasma CVD. Other methods for forming the metallic layer 5 include liquid-phase deposition methods, such as plating, the sol-gel method, and spin coating. Particularly, the metallic layer 5 is preferably a vapor-deposited film or a sputtered film. In this case, the adhesiveness of the negative electrode layer 4 (the metallic layer 5) to the solid electrolyte layer 2 can be further increased, so that the deterioration of the cycle characteristics can be further suppressed.

The thickness of the metallic layer 5 is preferably not less than 5 nm, more preferably not less than 10 nm, preferably not more than 800 nm, and more preferably not more than 500 nm. When the thickness of the metallic layer 5 is equal to or larger than the above lower limit, the adhesiveness thereof to the solid electrolyte layer 2 can be further increased, so that the deterioration of the cycle characteristics can be further suppressed. When the thickness of the metallic layer 5 is equal to or smaller than the above upper limit, volume expansion during charge and discharge can be further suppressed.

An example of the metallic sodium layer 6 that can be used is a metallic sodium foil. The metallic sodium foil can be obtained by rolling metallic sodium into shape. Furthermore, the metallic sodium layer 6 can be formed by pressure bonding the metallic sodium foil onto the metallic layer 5 with a pressing machine or the like. In doing so, the pressing temperature may be, for example, not lower than 80° C. and not higher than 100° C. The pressure during pressing may be, for example, not less than 5 MPa and not more than 100 MPa.

The metallic sodium layer 6 may be formed by charging. Specifically, the metallic sodium layer 6 may be formed by previously forming only the metallic layer 5 on the surface of the solid electrolyte layer 2 and allowing metallic sodium to uniformly precipitate on the surface of the metallic layer 5 during charge.

The thickness of the metallic sodium layer 6 is preferably not less than 1 μm, more preferably not less than 5 μm, still more preferably not less than 10 μm, preferably not more than 1000 μm, and more preferably not more than 800 μm. When the thickness of the metallic sodium layer 6 is equal to or larger than the above lower limit, the handleability can be further increased. When the thickness of the metallic sodium layer 6 is equal to or smaller than the above upper limit, an inconvenience can be more certainly prevented that, in pressure-bonding the metallic sodium layer 6 onto the metallic layer 5, an end of the metallic sodium layer 6 protrudes to the outside of the laminate and around to the positive electrode layer 3, resulting in the occurrence of a short-circuit.

In the present invention, at least one type of metal contained in the metallic layer 5 may be alloyed with metallic sodium contained in the metallic sodium layer 6. Furthermore, a diffusion layer may be provided at the interface between the metallic layer 5 and the metallic sodium layer 6. The diffusion layer may be a layer of an alloy of metal contained in the metallic layer 5 and metallic sodium contained in the metallic sodium layer 6. When a diffusion layer containing such an alloy is formed, the battery characteristics, such as the rate characteristics, of the sodium-ion secondary battery 1 can be further increased.

The negative electrode layer 4 may contain a solid electrolyte powder, a conductive agent and/or so on without interfering with the effects of the invention. The solid electrolyte powder and conductive agent used may be the same materials as those contained in the above-described positive electrode layer 3.

(Current Collector Layer)

A current collector layer may be provided on each of the positive electrode layer 3 and the negative electrode layer 4. More specifically, a current collector layer may be provided on each of the respective outside principal surfaces of the positive electrode layer 3 and the negative electrode layer 4 opposite to the solid electrolyte layer 2.

The material for the current collector layer is not particularly limited, but metallic materials, such as aluminum, titanium, silver, copper, stainless steel or an alloy of any of them, can be used. These metallic materials may be used singly or in combination of two or more of them. The alloy of any of them means an alloy containing at least one of the above types of metals.

The method for forming the current collector layer is not particularly limited and examples include physical vapor deposition methods, such as evaporation coating and sputtering, and chemical vapor deposition methods, such as thermal CVD, MOCVD, and plasma CVD. Other methods for forming the current collector layer include liquid-phase deposition methods, such as plating, the sol-gel method, and spin coating. However, the current collector layer is preferably formed on the positive electrode layer 3 or the negative electrode layer 4 by sputtering because excellent adhesiveness is provided.

Hereinafter, the present invention will be described in more detail with reference to specific examples. The present invention is not at all limited to the following examples and can be embodied in appropriately modified forms without changing the gist of the invention.

### EXAMPLES 1 TO 4 AND COMPARATIVE EXAMPLE 1

(a) Making of Member for Positive Electrode Layer/Solid Electrolyte Layer

2Na₂O—Fe₂O₃-2P₂O₅ glass to be a positive-electrode active material precursor in a positive electrode layer was made by a melting method. The obtained 2Na₂O—Fe₂O₃-2P₂O₅ glass was coarsely ground in a ball mill and then wet ground in a planetary ball mill, thus making a glass powder.

Meanwhile, β″-alumina (manufactured by Ionotec Ltd.) was coarsely ground in a ball mill and then air classified to make a solid electrolyte powder.

Acetylene black (“SUPER C65” manufactured by TIMCAL) was used, as it was, as a conductive agent in the positive electrode layer. The glass powder to be a positive-electrode active material precursor, the solid electrolyte powder, and the conductive agent were mixed at a weight ratio of 72:25:3, thus obtaining a mixture. Next, relative to 100 parts by mass of the obtained mixture, 10 parts by mass of polypropylene carbonate was added as a binder to the mixture and N-methyl-2-pyrrolidinone was further added as a solvent to the mixture to form a paste.

On the other hand, a β″-alumina plate (manufactured by Ionotec Ltd.) was used as a solid electrolyte layer as it was.

The above paste was applied onto the solid electrolyte layer and then dried. The application of the paste was performed so that the amount of positive-electrode active material supported reached 4.5 mg/cm². Next, the paste was fired at 500° C. for 30 minutes in a mixed gas of N₂/H₂=96/4 v/v %, thus making a member for a positive electrode layer/solid electrolyte layer.

Next, a current collector layer made of Al was formed on the surface of the positive electrode layer in the member for a positive electrode layer/solid electrolyte layer, using a sputtering device. The current collector layer was formed with a thickness of 500 nm.

(b) Making of Negative Electrolyte Layer

In Examples 1 to 4, a metallic layer was made on the principal surface of the solid electrolyte layer located opposite to the positive electrode layer in the member for a positive electrode layer/solid electrolyte layer, using a sputtering device (item number “SC-701AT” manufactured by Sanyu Electron Co., Ltd.). In Examples 1 and 4, an Au film with a thickness of 77 nm was made as the metallic layer. In Example 2, a Sn film with a thickness of 48 nm was made as the metallic layer. In Example 3, a Bi film with a thickness of 54 nm was made as the metallic layer. In Comparative Example 1, no metallic layer was formed.

Meanwhile, a metallic sodium foil was obtained by rolling metallic sodium into shape. Next, the metallic sodium foil was attached to the surface of the above-described metallic layer in Examples 1 to 3 or attached to the surface of the above-described solid electrolyte layer in Comparative Example 1, and then pressure-bonded at 90° C. with a pressing machine (pressure during pressing: 20 MPa). Thus, a metallic sodium layer with a thickness of 296 μm was formed on the metallic layer, thus making a negative electrode layer. In Example 4, charging in a charge and discharge test to be described later was performed for one cycle, with no metallic sodium foil bonded to the surface of the metallic layer, to allow metallic sodium to uniformly precipitate on the surface of the metallic layer. Thus, a metallic sodium layer with a thickness of 3 μm was formed on the surface of the metallic layer, thus making a negative electrode layer. In the above manners, sodium-ion all-solid-state secondary batteries were produced.

(c) Production of Test Battery

Each of the sodium-ion all-solid-state secondary batteries obtained through the above steps was placed on a lower lid of a coin cell and covered with an upper lid to produce a CR2032-type test battery. The formation of the metallic sodium layer in the step (b) and the step (c) were performed in an argon atmosphere with a dew point of −70° C. or lower.

(d) Charge and Discharge Test

The produced CR2032-type test batteries underwent CC (constant-current) charging from the open circuit voltage to 4.5 Vat 30° C. Next, the test batteries underwent CC discharging from 4.5 V to 2 V and were determined in terms of average discharge voltage and discharge capacity. These characteristics were evaluated at a C-rate of 0.2 C.

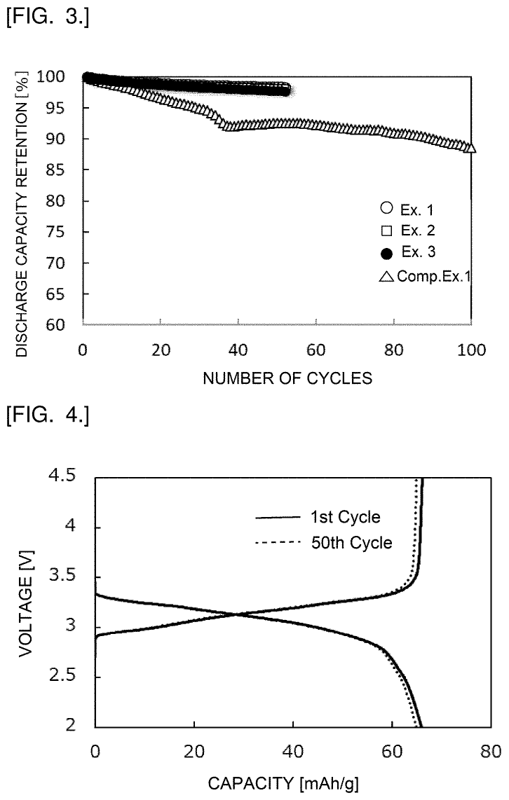

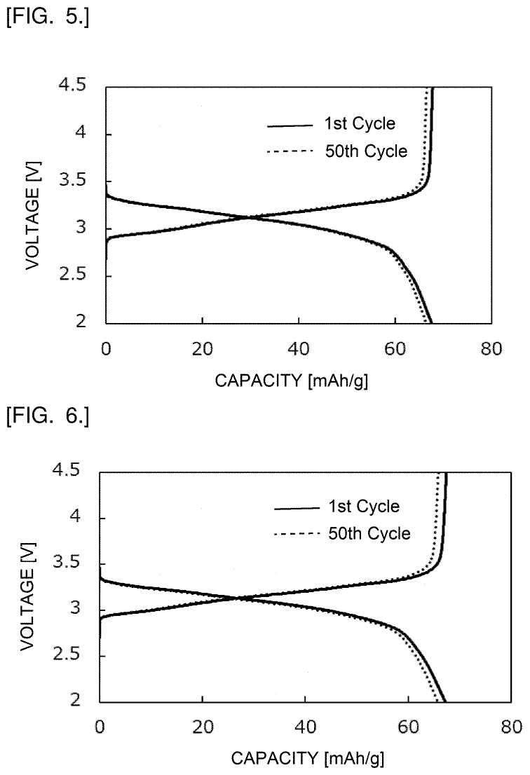

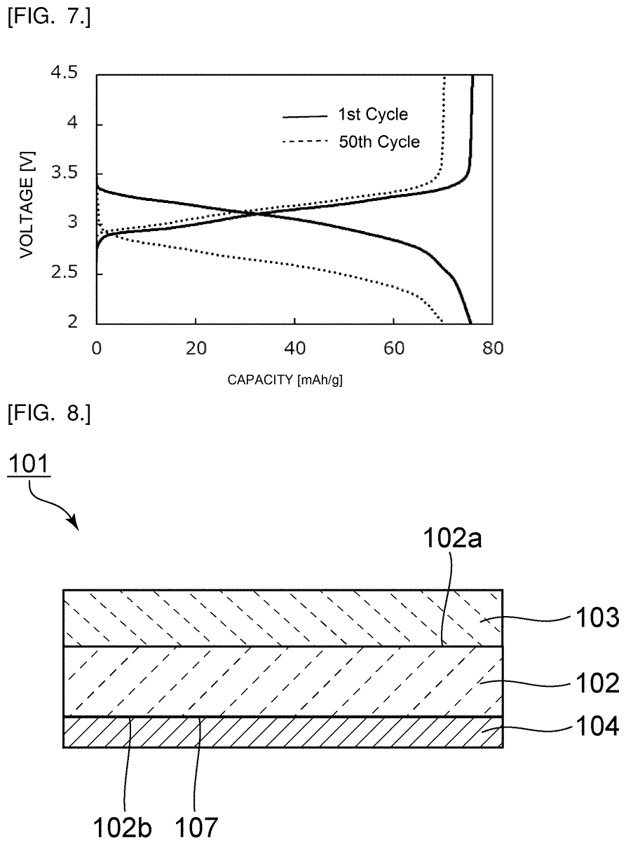

FIG. 2 shows the relationship between the number of cycles and the average discharge voltage in the test batteries produced in the working examples and the comparative example. FIG. 3 shows the relationship between the number of cycles and the discharge capacity retention in the test batteries produced in the working examples and the comparative example. FIGS. 4 to 7 sequentially show charge and discharge curves in the first cycle and the 50th cycle in the respective test batteries produced in Example 1, Example 2, Example 3, and Comparative Example 1. Table 1 shows respective amounts of change in average discharge voltage ((discharge voltage in 50th cycle)/(discharge voltage in first cycle)×100(%)) and respective discharge capacity retentions ((discharge capacity after 50th cycle)/(discharge capacity after first cycle)×100(%)) in the test batteries produced in the working examples and the comparative example.

TABLE 1

| | | Ex. 1 | Ex. 2 | Ex. 3 | Ex. 4 | Comp. Ex. 1 |
|---|---|---|---|---|---|---|
| Metallic Layer | | Au film | Sn film | Bi film | Au film | No metallic film |
| Average discharge | 1st cycle | 3.035 | 3.027 | 3.014 | 3.019 | 3.012 |
| voltage [V] | 50th cycle | 3.037 | 3.029 | 3.011 | 3.018 | 2.599 |
| | Amount of | 0.002 | 0.002 | −0.003 | −0.001 | −0.413 |
| | change | | | | | |
| Discharge capacity | 1st cycle | 66.1 | 67.7 | 67.3 | 66.8 | 75.8 |
| [mAh/g] | 50th cycle | 65 | 66.5 | 65.7 | 64.8 | 70.2 |
| | Retention[%] | 98.3 | 98.2 | 97.6 | 97.0 | 92.6 |

As is obvious from FIGS. 2 to 7 and Table 1, it can be seen that the test batteries in Examples 1 to 4 in which a metallic layer was provided between a solid electrolyte layer and a metallic sodium layer exhibited excellent charge/discharge cycle characteristics . It can also be seen that the test battery in Comparative Example 1 in which no metallic layer was provided between a solid electrolyte layer and a metallic sodium layer exhibited poor charge/discharge cycle characteristics.

When the powder X-ray diffraction patterns of the metallic layer in Example 1 before the charge and discharge test, after the initial charging, after the initial discharging, after charging in the second cycle, and after discharging in the second cycle were checked, it was confirmed that Na₂Au crystals or NaAu₂ crystals due to reactions between metallic sodium and Au precipitated. It was confirmed from this that when Au is used as the metallic layer, the above-described reactions due to charge and discharge occur to promote the alloying of Au with metallic sodium.

### REFERENCE SIGNS LIST

1 . . . sodium-ion secondary battery
2 . . . solid electrolyte layer
2a . . . first principal surface
2b ... second principal surface
3 . . . positive electrode layer
4 . . . negative electrode layer
5 . . . metallic layer
6 . . . metallic sodium layer
7 . . . interface
8 . . . member for a sodium-ion secondary battery

1. A member for a sodium-ion secondary battery comprising:
a solid electrolyte layer having sodium-ion conductivity;
a metallic sodium layer disposed on one of both principal surfaces of the solid electrolyte layer and made of metallic sodium; and
a metallic layer provided between the solid electrolyte layer and the metallic sodium layer and made of a metal different from the metallic sodium.

2. The member for a sodium-ion secondary battery according to claim 1, wherein the metallic layer is a vapor-deposited film or a sputtered film.

3. The member for a sodium-ion secondary battery according to claim 1, wherein the metallic layer contains at least one type of metal selected from the group consisting of Sn, Ti, Bi, Au, Al, Cu, Sb, and Pb.

4. The member for a sodium-ion secondary battery according to claim 1, wherein at least one type of metal contained in the metallic layer is a metal capable of absorbing and releasing sodium ions.

5. The member for a sodium-ion secondary battery according to claim 1, wherein at least one type of metal contained in the metallic layer is alloyed, at an interface between the metallic sodium layer and the metallic layer, with the metallic sodium contained in the metallic sodium layer.

6. A sodium-ion secondary battery comprising the member for a sodium-ion secondary battery according to claim 1.

7. The sodium-ion secondary battery according to claim 6, wherein
the solid electrolyte layer has a first principal surface and a second principal surface opposed to each other,
the sodium-ion secondary battery comprises:
a positive electrode layer provided on the first principal surface of the solid electrolyte layer; and
a negative electrode layer provided on the second principal surface of the solid electrolyte layer, and
the negative electrode layer contains the metallic sodium layer and the metallic layer.
